(19) United States
(12) Patent Application Publication
(10) Pub. No.: US 2002/0026310 A1
(43) Pub. Date: Feb. 28, 2002

(54) Real-time information receiving apparatus

(75) Inventors: Naoyuki Mochida, Yokohama-shi (JP); Harumine Yoshiba, Yokohama-shi (JP)

Correspondence Address: PEARNE & GORDON LLP, 526 SUPERIOR AVENUE EAST, SUITE 1200, CLEVELAND, OH, 44114-1484, US

(73) Assignee: Matsushita Electric Industrial Co., Ltd.

(21) Appl. No.: 09/935,089

(22) Filed: Aug. 22, 2001

(30) Foreign Application Priority Data
Aug. 25, 2000 (JP) P.2000-256109

(51) Int. Cl. G10L 21/00

(52) U.S. Cl. 704/201

(57) ABSTRACT

A packet receiving unit 5 receives a packet from a communication path 4 and stores the received packet into a jitter absorbing buffer 6. A decoding unit 7 receives a packet from the jitter absorbing buffer 6, and decodes this received packet, and thereafter, transfers the decoded packet to an output unit 8. A packet number judging means 9 counts a total number of packets which are stored in the jitter absorbing buffer 6, and judges as to whether or not this counted packet number exceeds a predetermined threshold value. When the counted packet number exceeds the threshold value, the packet number judging means 9 notifies this fact to a data discarding means 10. In the case that the data discarding means 10 is notified from the packet number judging means 9 by such a notification that the total number of packets stored in the jitter absorbing buffer 6 exceeds the threshold value, the data discarding means 10 discards either a portion or all of the packets stored in the jitter absorbing buffer 6. A packet discarding unit may be selected from a packet unit, or a byte unit.

### BACKGROUND OF THE INVENTION

1. Field of the Invention

The present invention is related to a real-time information receiving apparatus for receiving real-time information which is transferred via an asynchronous packet network, and more specifically, is directed to a receiving apparatus for receiving voice information (speech information) via the Internet.

2. Description of the Related Art

FIG. 17 shows a schematic block diagram of a conventional voice information transfer system for transferring voice information (speech information) corresponding to one of real-time information. In FIG. 1, voice information entered from an input source 1 into a transmission apparatus 30 is converted from analog data into digital data by a coding unit 2. A packet transmitting unit 3 receives the digital data from the coding unit 2 and packetizes the received digital data, and thereafter, transmits the packetized digital data to a communication path 4. The analog/digital data converting operation by the coding unit 2 is carried out at a constant rate, for instance, 64 Kbps. Since the digital data is packetized every same data amount in the packet transmitting unit 3, a total number of data packets per unit time is a constant, which are transmitted from the packet transmitting unit 3 to the communication path 4.

The communication path 4 corresponds to such a transfer path which is used to connect the transmission apparatus 30 with a reception apparatus 40, namely a transfer path where a transfer delay of a packet may occur.

A packet which is entered from the communication path 4 into the reception apparatus 40 is received by a packet receiving unit 5, and is temporarily stored into a jitter absorbing buffer 6. Thereafter, the stored packet is sent to a decoding unit 7 at predetermined timing, and then, is converted from digital data into analog data by this decoding unit 7, and thereafter, the converted analog data is sent to an output unit 8.

In the conventional voice information transfer system with employment of such an arrangement, in the case that a communication is commenced, and then, a first packet is received by the packet receiving unit 6, this first packet is once stored into the jitter absorbing buffer 6. When a data amount stored in the jitter absorbing buffer 6 exceeds a predetermined threshold value (jitter absorbing time), data is sent to the decoding unit 7 for the first time. Subsequently, the data is sent from the jitter absorbing buffer 6 to the decoding unit 7 at constant timing. As a consequence, even in such a case that a delay happens to occur in the communication path 4 during data communication, if this delay is shorter than or equal to the time duration corresponding to the data amount stored in the jitter absorbing buffer 6 at the first stage of the data communication, then the data can be transferred from the jitter absorbing buffer 6 to the decoding unit 7 at constant timing. Thus, when the delay happens to occur in the communication path 4, the data can be transferred to the output unit 8 without any interruption, and the voice can be reproduced without any interruption.

Also, in real-time transfer systems of voice and the like, the following real-time transfer system is widely used. In this real-time voice transfer system, while such a protocol as RTP (Real Time Protocol) is employed, a time stamp indicative of a transmission time instant is added to a packet in a transmission apparatus, whereas a received packet is decoded in accordance with this time stamp in a reception apparatus. Also, in this case, similar to the system of FIG. 17, the reception apparatus once stores a firstly received RTP packet into a jitter absorbing buffer, and commences a decoding operation of an RTP packet for the first time after jitter absorbing time has elapsed. In the case that this first RTP packet is decoded, a time stamp value contained in this RTP packet is set to a reference time instant of reproducing timing at which subsequent RTP packets are reproduced. In other words, a second RTP packet is decoded when such a time has passed which corresponds to a difference between a time stamp contained in this second RTP packet and the time stamp of the first RTP packet. That is to say, since the RTP protocol is employed, such a relative time instant that the decoding operation of the first RTP packet is commenced can be synchronized with a time instant when the transmission apparatus transmits the RTP packet.

However, in the above-explained conventional voice information transfer system, when the communication is commenced and then the first packet is received, the data is stored only for the predetermined jitter absorbing time. Thereafter, the decoding operation of the data is commenced, and the data is transferred to the decoding unit only at the predetermined constant timing. As a consequence, in such a case that the transfer delay with respect to the first-received data packet is large, the following problem may arise. That is, the timing at which the data packet received after the first data packet is reproduced may be delayed by this transfer delay time.

For instance, assuming now that a transfer delay of a first-received packet is equal to 1 second and also a jitter absorbing amount of a jitter absorbing buffer is equal to 500 millisecond, a reception apparatus stores such a data amount into the jitter absorbing buffer, which corresponds to the reproducing time of 500 milliseconds, after the first packet has been received. In other words, after 1.5 seconds has passed when the transmission apparatus commences the transmission, the data transfer operation from the jitter absorbing buffer to the decoding unit is commenced, and then, the reproducing operation of the voice data is commenced. Since the reception apparatus reproduces the received packet at predetermined timing, the subsequent voice data is similarly reproduced after 1.5 seconds when the transmission apparatus has transmitted the data. As a consequence, even when an averaged transfer delay between the transmission apparatus and the reception apparatus is equal to 0.5 seconds, in the case that a transfer delay of a first packet is equal to 1 second, the voice is similarly reproduced only by 1.5 seconds after the transmission apparatus has sent the data. Moreover, since this delay is not recovered during the communication operation, the resulting delay defined from the transmission operation up to the reproduction operation would always become 1.5 seconds, although the averaged delay time between the transmission apparatus and the reception apparatus is equal to 0.5 seconds, and also the jitter absorbing time is equal to 0.5 seconds.

FIG. 18 represents transmission/reception timing of data packets in the voice information transfer system of FIG. 17. As apparent from the drawing, in such a case that a first packet is largely delayed after a communication is commenced, as compared with averaged delay time, even when packets subsequent to the first packet can be received with such a delay time on the order of the averaged delay time, the delay time of the first packet cannot be recovered. The delay time for each packet defined by such operations that after the packet has been transmitted, and until the packet are decoded is made identical to each other, and is equal to such a time defined by merely adding the delay time of the first packet to the jitter absorbing time.

In such a system as a TDM system in which there is provided a commonly-used clock signal between a transmission apparatus and a reception apparatus, and further a delay occurred between the transmission apparatus and the reception apparatus is constant, since transfer delay time of a first packet is identical to averaged delay time, the above-explained problem does not occur. To the contrary, in such a system that there is no such a commonly-used clock signal between a transmission apparatus and a reception apparatus, the above-explained problem may arise. More specifically, to transfer an IP packet in the Internet, a router provided at a relay stage is required to update routing information when a first packet of a communication is received, but is not required to update the routing information when packets subsequent to the first packet are received. As a result, there is such a trend that delay time of the first packet in the communication becomes larger than average delay time. Also, in a layer-3 switch which has been widely used in recent year, there is such a case that when a first packet is received during communication, a short-cut path is dynamically set within a router. There is such a trend that delay time of a first packet during communication is becoming larger, as compared with delay time of other packets. As a consequence, in such a case that a transfer delay of a first packet during communication becomes larger than an averaged transfer delay, and furthermore, delays of packets received after the first packet are substantially equal to averaged delay time, although a transmission apparatus transmits packets in a predetermined time interval, a reception apparatus continuously receives these packets in a shorter time interval than the transmission interval. However, in the above-explained conventional voice information transfer system, there are such problems that such a phenomenon could not be detected, and therefore, the delay time required for transferring the first packet during the communication could not be recovered.

Also, in the case that data is transmitted by employing the RTP protocol, while a starting time instant at which a first RTP packet is decoded during a communication is employed as a reference time instant, RTP packets subsequent to the first RTP packet are decoded when a time duration has passed and this time duration corresponds to a difference between a time stamp of the first RTP packet and other time stamps thereof. As a result, similar to the above-explained prior art system, in the case that a large delay happens to occur when the first packet is transferred, there is such a problem that the reproducing timing at which the packets received after this large delay occurs would be delayed by the transfer delay time thereof.

### SUMMARY OF THE INVENTION

The present invention has been made to solve these problems of such conventional systems, and therefore, has an object to provide a real-time information receiving apparatus capable of recovering a transfer delay which happens to occur at the beginning of a communication, while a communication is continued. Also, another object of the present invention is to provide a real-time information receiving apparatus operable under such a condition that when packets are continuously reached in a short time interval in a first stage of a communication, this real-time information receiving apparatus detects this fact, and delay time occurred while a first packet is transferred can be recovered in an earlier stage.

A real-time information receiving apparatus, according to a first aspect of the present invention, is featured by such a real-time information receiving apparatus for receiving real-time information transferred via an asynchronous packet network, comprising: a packet receiving unit for receiving a real-time information packet which is transmitted at a constant coding speed, while having a constant packet length; a jitter absorbing buffer for temporarily storing thereinto the real-time information packet received by the packet receiving unit; a decoding unit for decoding data stored in the jitter absorbing buffer; packet number judging means for measuring a total number of packets stored in the jitter absorbing buffer and for comparing the measured total packet number with a preset threshold value, and also for notifying the comparison result to data discarding means; and data discarding means for discarding either a portion or all of the packets stored in the jitter absorbing buffer based upon the comparison result of the packet number comparing means.

In accordance with a first aspect of the present invention, even in such a case that the transfer delay of the first packet after the commencement of the communication becomes longer than an averaged transfer delay and therefore, a larger number of packets than the jitter absorbing time are stored in the jitter absorbing buffer, the data stored in the jitter absorbing buffer can be discarded while the voice data is reproduced. The real-time information receiving apparatus according to claim 1 can own such an effect that the delay time defined by that after the packet is transmitted from the transmission apparatus and until the voice is reproduced can be reduced, and furthermore, this delay time can be suppressed to such a value, i.e., on the order of the averaged transfer delay of the network.

A real-time information receiving apparatus, according to a second aspect 2 of the present invention, is featured by such a real-time information receiving apparatus for receiving real-time information transferred via an asynchronous packet network, comprising: a packet receiving unit for receiving a real-time information packet which is transmitted at a constant coding speed, while having a constant packet length; a jitter absorbing buffer for temporarily storing thereinto the real-time information packet received by the packet receiving unit; a decoding unit for decoding data stored in the jitter absorbing buffer; packet number judging means for measuring a total number of packets stored in said jitter absorbing buffer and for comparing the measured total packet number with a preset threshold value, and also for notifying the comparison result to a continuation monitoring timer; and a continuation monitoring timer for judging as to whether or not such a time period during which the comparison result of the packet number judging means exceeds a threshold value is continued over a predetermined threshold value, and for notifying such a fact that the time period is continued over the predetermined threshold value to data discarding means; and data discarding means for discarding either a portion or all of the packets stored in the jitter absorbing buffer based upon the comparison result of the continuation monitoring timer.

In accordance with the present invention, even in such a case that the transfer delay of the first packet after the commencement of the communication is longer than an averaged transfer delay and therefore, the larger number of packets than the jitter absorbing time are stored in the jitter absorbing buffer, and furthermore, this condition is continued, the data discarding means can discard the data. Even when the arrivals of the packets are considerably fluctuated due to a certain factor during the communication, these packets are reached in the burst manner, and these packets temporarily exceed the discard judging threshold value of the jitter absorbing buffer, if this continuous time is short, then the data discarding means does not discard the data. As a consequence, the real-time information receiving apparatus of claim 2 can have such an advantage that the data discarding operation is carried out only for the delay which occurs in the first stage during the communication, while no data discarding operation is carried out with respect to the delay occurred during the communication, and also the delay produced in the first stage of the communication can be recovered.

A real-time information receiving apparatus, according to a third aspect of the present invention, is featured by such a real-time information receiving apparatus for receiving real-time information transferred via an asynchronous packet network, comprising: a packet receiving unit for receiving a real-time information packet which is transmitted at a constant coding speed, while having a constant packet length; a jitter absorbing buffer for temporarily storing thereinto the real-time information packet received by the packet receiving unit; a decoding unit for decoding data stored in the jitter absorbing buffer; a reception packet counter for counting a total number of real-time information packets received by the packet receiving unit after a communication is commenced; comparing means for comparing the total packet number counted by the reception packet counter with a predetermined threshold value; and data discarding means for discarding either a portion or all of the packets stored in the jitter absorbing buffer based upon the comparison result of the comparing means, which is acquired at a time instant when a predetermined time period has elapsed after the communication has been commenced.

The real-time information receiving apparatus according to the present invention can own the following effects. That is, by discarding the packets based upon a total number of these packets received just after the communication is commenced, it is possible to avoid such a condition that the transfer delay of the first packet is stored. In particular, since the data discarding operation of the data discarding means is executed just after the communication is commenced, it is possible to shorten such a time duration during which the adverse influence caused by the transfer delay occurred while the first packet is transferred is given.

The real-time information receiving apparatus, according to a fourth aspect of the present invention, is featured by that while employing such a timer for outputting a time-up signal after a predetermined time period has passed from a time instant when a first packet is received, or the data is decoded for the first time since the communication has been commenced, the comparison result of the comparing means can be obtained at the time instant when the predetermined time has passed after the communication has been commenced.

A real-time information receiving apparatus, according to a fifth aspect of the present invention, is featured by that the data discarding means discards either a portion or all of the packets stored in the jitter absorbing buffer in the unit of a packet.

A real-time information receiving apparatus, according to a sixth aspect of the present invention, is featured by that the data discarding means discards either a portion or all of the packets stored in the jitter absorbing buffer in the unit of a byte. The real-time information receiving apparatus of the present invention can own the following effects. That is, even in such a case that the packet length is long and if the data is discarded in the unit of the packet, then the quality of the voice to be reproduced is considerably deteriorated, while the deterioration of the voice caused by discarding the data can be suppressed, the delay time defined by that after the packet is transmitted from the transmission apparatus and until the voice is reproduced can be reduced, and furthermore, this delay time can be suppressed to such a value, i.e., on the order of the averaged transfer delay of the network.

### BRIEF DESCRIPTION OF THE DRAWINGS

FIG. 1 is a schematic structural diagram of a transfer system with employment of a reception apparatus of a first embodiment mode of the present invention.

FIG. 2 is a diagram for indicating an example of packet transmission/reception timing in the reception apparatus of the first embodiment mode.

FIG. 3 is a diagram for indicating another example of packet transmission/reception timing in the reception apparatus of the first embodiment mode.

FIG. 4 is a schematic structural diagram of a reception apparatus according to a second embodiment mode of the present invention.

FIG. 5 is a diagram for representing an example of data discarding operation performed in the reception apparatus of the second embodiment mode of the present invention.

FIG. 6 is a schematic structural diagram of a reception apparatus according to a third embodiment mode of the present invention.

FIG. 7 is a diagram for representing an example of data discarding operation performed in the reception apparatus of the third embodiment mode of the present invention.

FIG. 8 is a diagram for indicating a first structural example of the data discarding means.

FIG. 9 is a diagram for showing an example of data discarding operation executed in the first structural example of the data discarding means.

FIG. 10 is a diagram for indicating an example of data discarding operation executed in a second structural example of the data discarding means.

FIG. 11 is a diagram for showing a third structural example of the data discarding means.

FIG. 12 is a diagram for indicating one example in which a packet is discarded, and dummy data is inserted in the third structural example of the data discarding means.

FIG. 13 is a diagram for showing another example in which a packet is discarded, and dummy data is inserted in the third structural example of the data discarding means.

FIG. 14 is a diagram for indicating a fourth structural example of the data discarding means.

FIG. 15 is a diagram for showing an example of data discarding operation executed in the fourth structural example of the data discarding means.

FIG. 16 is a diagram for indicating an example of data discarding operation executed in a fifth structural example of the data discarding means.

FIG. 17 is a diagram for representing the schematic structure of the prior art of the voice information transfer system.

FIG. 18 is a diagram for indicating packet transmission/reception timing in the voice information transfer system of FIG. 17.

### DESCRIPTION OF THE PREFERRED EMBODIMENTS

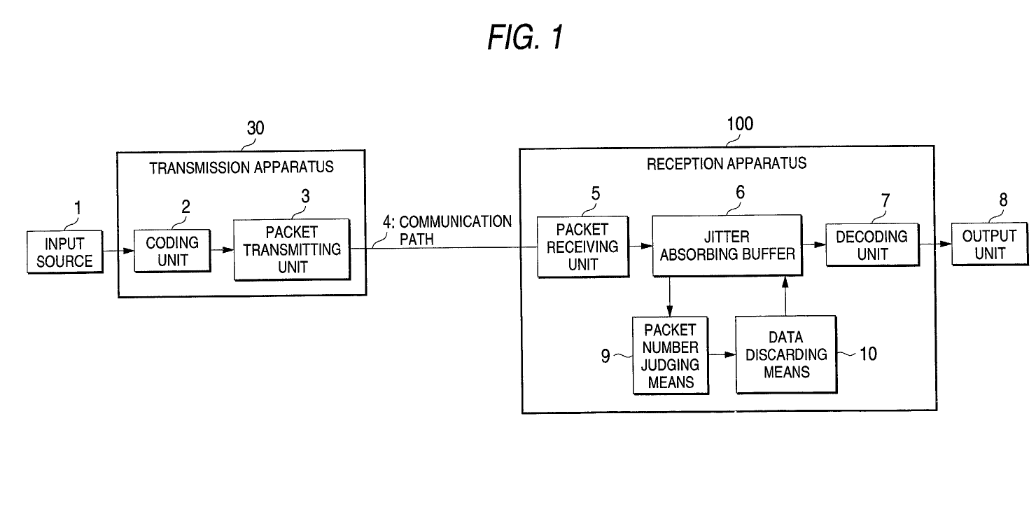

Referring now to FIG. 1 to FIG. 16, various embodiment modes of the present invention will be described.

(First Embodiment Mode)

FIG. 1 shows a schematic arrangement of a transfer system with employment of a reception apparatus according to a first embodiment mode of the present invention. In FIG. 1, real-time data which is entered from an input source 1 to a transmission apparatus 30 is packetized, and then, the packetized real-time data is transmitted via a communication path 4 to a reception apparatus 100. A coding unit 2 codes the real-time data entered from the input source 1 at a predetermined coding speed, and then, sends the coded real-time data to a packet transmitting unit 3. In such a case that a microphone is used as the input source 1, data which is transmitted from the input source 1 corresponds to analog voice (speech) data, and the coding unit 2 converts the analog voice data into digital voice data. At this time, the coding unit 2 executes the data coding operation in accordance with such a coding rule as, for instance, the 64 Kbps μ-law used in the ISDN (Integrated Services Digital Network). A packet transmitting unit 3 packetizes the digital data which is transmitted from the coding unit 2 at a predetermined speed, and then, sends the digital data packet to the communication path 4. It should be noted that the packet transmitting unit 3 packetizes the digital data every constant data length so as to make the sizes of all of the data packets identical to each other. As a consequence, such an interval after which the packet transmitting unit 3 transmits each data packets to the communication path 4 is a constant.

The communication path 4 corresponds to such a transfer path used to connect the packet transmitting unit 3 of the transmission apparatus 30 with a packet receiving unit 5 of the reception apparatus 100. There is no such a clock signal which is commonly used between the packet transmitting unit 3 and the packet receiving unit 5, and thus, the data transmission/reception operation are carried out in an asynchronous mode. As a suitable example of such an asynchronous communication, an IP (Internet Protocol) communication executed in the Internet and the like are conceived. Since there is no such a commonly-used clock signal between the packet transmitting unit 3 and the packet receiving unit 5, transfer delays occurred while data are transferred via the communication path 4 are not constant, but may be varied due to congestion conditions of the communication paths.

The packet receiving unit 5 is employed so as to receive a packet (data packet) from the communication path 4, and to store the received packet into a jitter absorbing buffer 6 corresponding to a temporary storage place. The jitter absorbing buffer 6 corresponds to a first-in/first-out type buffer (FIFO type buffer) for receiving a packet from the packet receiving unit 5 to temporarily store thereinto the received packet. A decoding unit 7 receives a packet from the jitter absorbing buffer 6 and decodes this received packet, and thereafter transfers the decoded packet to the output unit 8. In such a case that packetized data is voice data, the decoding unit 7 returns digitalized voice data to an analog (voice) signal, and then, transfers the analog voice signal to the output unit 8.

To reproduce voice in the output unit 8 without any interruption, the decoding unit 7 is required to send data to the output unit 8 without any interruption. However, since the communication path 4 corresponds to such a transfer path having a delay variation, when a communication is commenced and also a decoding operation is commenced immediately after a first packet is received, if a delay happens to occur in the communication path 4, then such a condition will occur. That is, data to be decoded is not yet delivered to the output unit 8. To avoid this difficult condition, the decoding unit 7 does not execute the decoding operation for a predetermined time duration (namely, jitter absorbing time) after the communication has been commenced and the first packet is received, but this decoding unit 7 stores the received packet into the jitter buffer 6, and then commences the decoding operation for the first time after the predetermined time has passed.

A packet number judging means 9 corresponds to a means for measuring (counting) a total number of packets stored in the jitter absorbing buffer 6, and for judging as to whether or not this measured packet number exceeds a preselected threshold value. When the measured packet number exceeds the threshold value, the packet number judging means 9 informs this fact to a data discarding means 10. In such a case that the data discarding means 10 is notified by the packet number judging means 9 as to such a fact that a total number of packets stored in the jitter absorbing buffer 6 exceeds a threshold value, this data discarding means 10 discards either a portion or all of the packets which are temporarily stored in the jitter absorbing buffer 6. As to a discarding unit of packets, either a packet discarding unit or a byte discarding unit may be employed. In the case that packets are discarded in the byte unit, such data which may give a small adverse influence to a transfer quality by being discarded is selected as data to be discarded. When the real-time information corresponds to voice information, no speech data (portion of data from a silent period) is selected as the data which may give a small adverse influence to a transfer quality by being discarded.

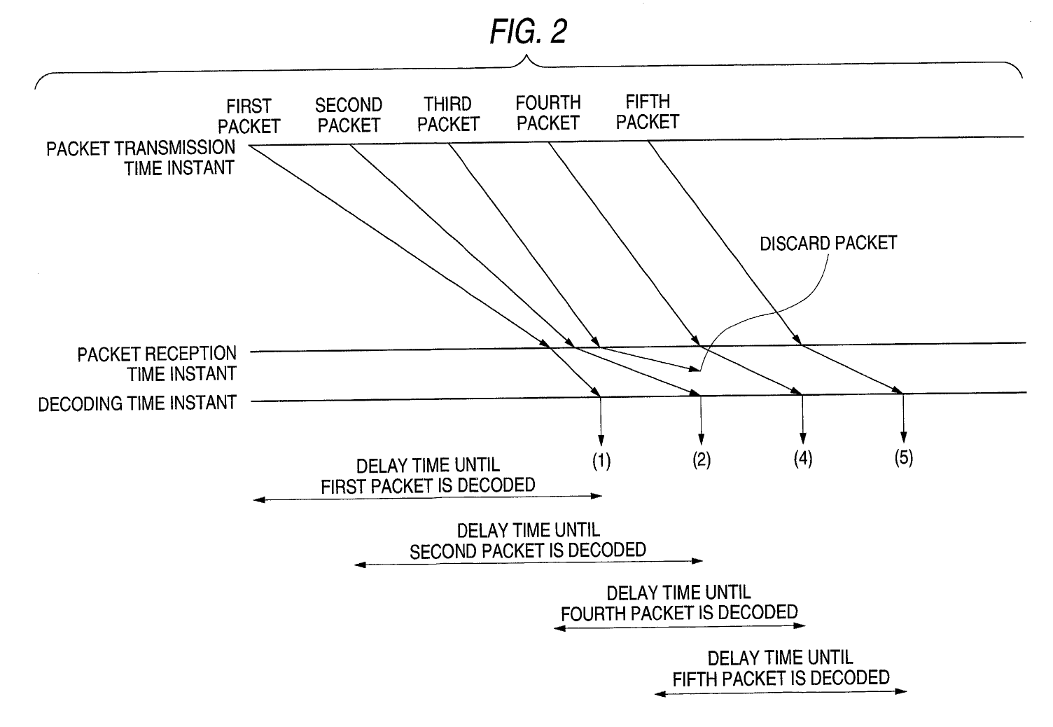

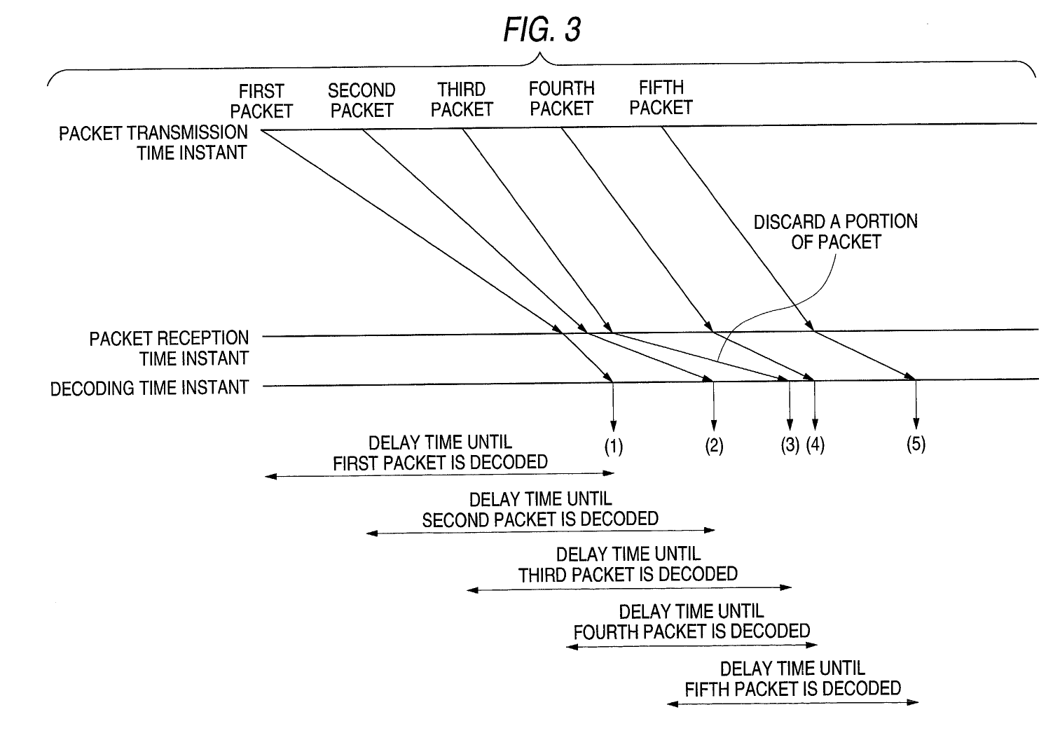

FIG. 2 and FIG. 3 illustrate packets are transmitted/received between the transmission apparatus and the reception apparatus after the communication is commenced in the transfer system shown in FIG. 1. FIG. 2 represents such a packet transmission/reception operation executed in the case that the data discarding means 10 discards packets in the packet unit, whereas FIG. 3 shows such a packet transmission/reception operation performed in the case that the data discarding means 10 discards packet in the byte unit.

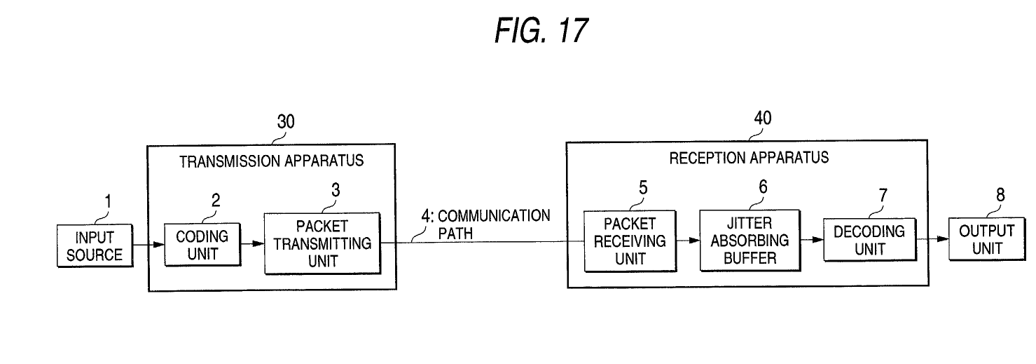

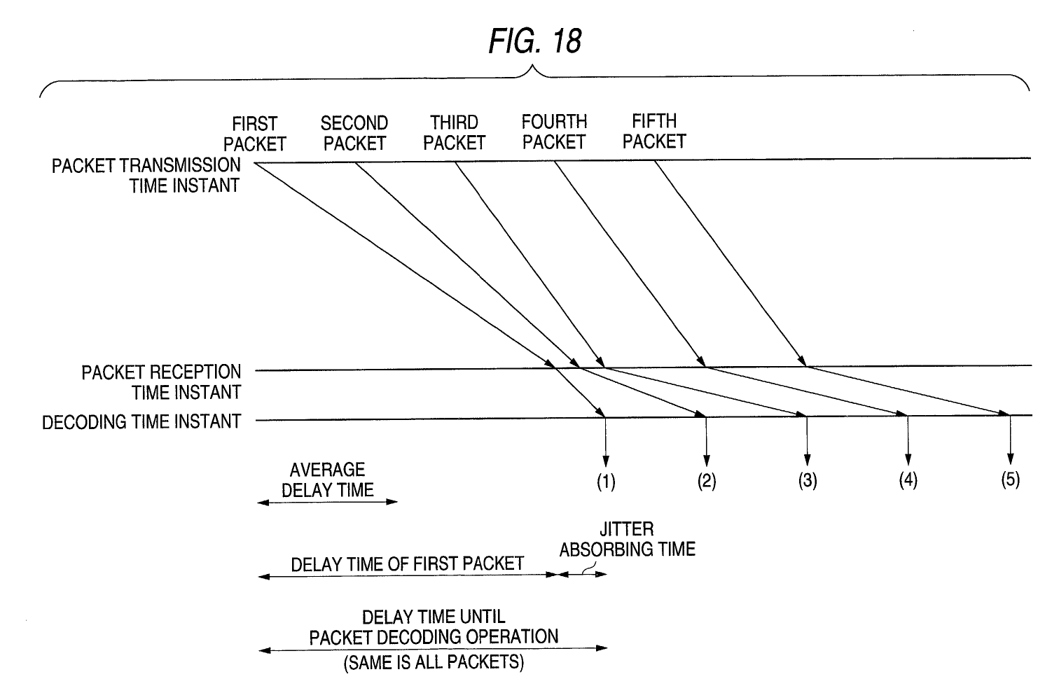

In FIG. 2, it is so assumed that similar to the case of FIG. 17, after the communication is commenced, a first packet is largely delayed, as compared with the averaged delay time, and when a third packet is received, a total number of packets stored in the jitter absorbing buffer 6 exceeds the threshold value. Under this assumed condition, the data discarding means 10 is operated to discard any one of the second packet and the third packet stored in the jitter absorbing buffer 6. In this case, FIG. 2 represents such a condition that the third packet is not decoded, but is discarded. As a consequence, a fourth packet is decoded at such timing when the third packet is originally decoded. At this time, both delay time occurred until the first packet is decoded, and delay time, until the second packet is decoded are equal to a summation made of the delay time of the first packet and the jitter absorbing time. To the contrary, delay time produced until a fourth packet is decoded and delay time produced until a fifth packet is decoded are equal to such a value obtained by subtracting a packet transmission interval from this delay time summation. In other words, the delay time occurred until the relevant packet is decoded can be reduced.

Also, in the case of FIG. 3, assuming now that when a third packet is received, a total number of packets stored in the jitter absorbing buffer 6 exceeds the threshold value, the data discarding means 10 is operated so as to discard a portion of a second packet, or a portion of the third packet stored in the jitter absorbing buffer 6 in the unit of the byte. In this case, FIG. 3 shows such a condition that a portion of the third packet is discarded. A portion of the third packet is not decoded, but is discarded, so that the time required to decode this third packet can be shortened. As a consequence, a fourth packet is started to be decoded at such timing when the discarded portion of the third packet is originally decoded. At this time, delay time occurred until the first packet is decoded, delay time occurred until the second packet is decoded, and also delay time until the third packet is decoded are equal to a summation made of the delay time of the first packet and the jitter absorbing time. To the contrary, delay time occurred until a fourth packet is decoded and delay time occurred until a fifth packet is decoded are equal to such a value obtained by subtracting such time equivalent to the discarded data amount from this delay time summation. In other words, the delay time occurred until the relevant packet is decoded can be reduced.

As described above, in accordance with the first embodiment mode, in the case that the delay happens to occur in the first packet when the communication is commenced, this delay can be reduced. As a consequence, the voice (speech) reception service with the high quality can be provided. Also, in such a case that when the data is discarded in the unit of the byte, the packet length becomes large, whereas when the data is discarded in the unit of the packet, the quality of voice after the decoding operation is considerably deteriorated, it is possible to reduce the delay time defined by that after the packet has been transmitted from the transmission apparatus, and until the voice is reproduced, while suppressing the deterioration of the voice caused by discarding the data. Accordingly, it is possible to provide such a voice reception service having the high quality.

(Second Embodiment Mode)

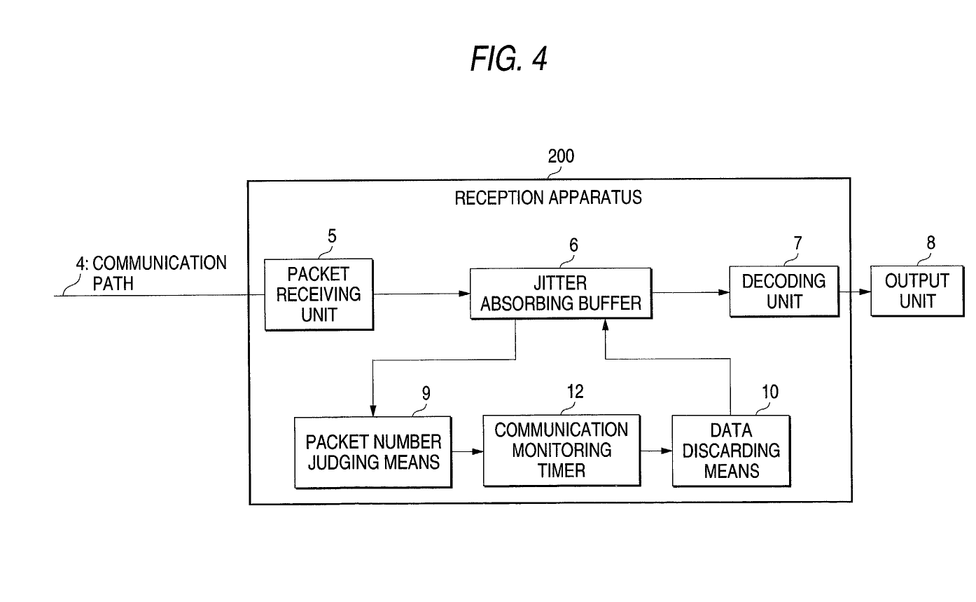

FIG. 4 represents a schematic arrangement of a reception apparatus according to a second embodiment mode of the present invention. Similar to the reception apparatus 100 of FIG. 1, the reception apparatus 200 receives real-time data from a communication path 4, which has been packetized, and then outputs decoded real-time data to an output unit 8. This reception apparatus 200 is provided with the same structural elements as those of the reception apparatus 100 except that a continuation monitoring timer 12 is employed.

In such a case that a total number of packets stored in a jitter absorbing buffer 6 exceeds a preselected threshold value, a packet number judging means 9 notifies this fact to the continuation monitoring timer 12. In the case that a total number of packets stored in the jitter absorbing buffer 6 becomes smaller than a preselected threshold value, the packet number judging means 9 notifies such a fact to the continuation monitoring timer 12.

When the packet number judging means 9 notifies such a fact that the total packet number exceeds the threshold value, the continuation monitoring timer 12 initiates a time in order to judge as to whether or not this fact is continued over a predetermined time period. When a count value of this timer becomes a predetermined value, the continuation monitoring timer 12 judges that such a condition under which the total packet number exceeds the threshold value is continued over a predetermined time period, and then notifies this fact to a data discarding means 10. In the case that the continuation monitoring timer 12 receives from the packet number judging means 9 such a notification that the total packet number becomes smaller than the threshold value, if there is an initiated timer, then the continuation monitoring timer 12 resets this timer under initiation.

When the data discarding means 10 operated in the unit of the packet receives the notification sent from the continuation monitoring timer 12, the data discarding means discards either a portion of the packets or all of the packets stored in the jitter absorbing buffer 6. With respect to a discarding unit of packets, either a packet discarding unit or a byte discarding unit may be employed. In the case that packets are discarded in the byte unit, such data which may give a small adverse influence to a transfer quality by being discarded is selected as data to be discarded. When the real-time information corresponds to voice information, no speech data (portion of data from silent period) is selected as the data which may give a small adverse influence to a transfer quality by being discarded.

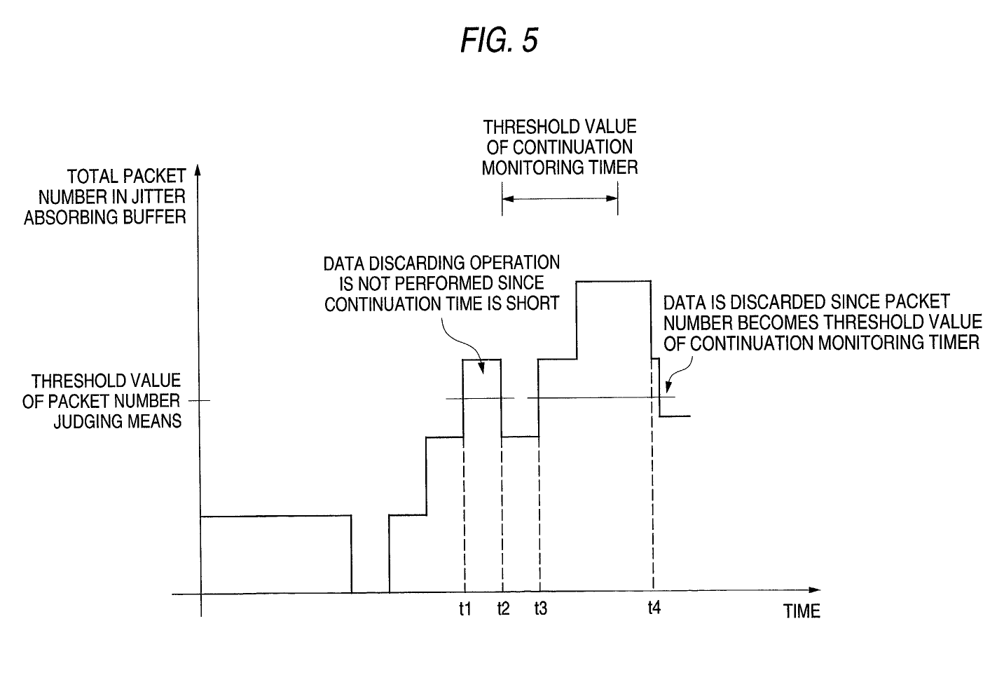

FIG. 5 indicates an example of a judgment as to the above-explained continuous period, and of discarding of data. In FIG. 5, at a time instant “t1” when a total number of packets stored in the jitter absorbing buffer 6 firstly exceeds the threshold value of the packet number judging means 9, this packet number judging means 9 starts to notify this fact to the continuation monitoring timer 12. Since this total packet number becomes smaller than the threshold value at a time instant “t2”, this total packet number does not exceed the threshold value of the continuation monitoring timer 12. As a consequence, the data stored in the jitter absorbing buffer 6 are not discarded. At a time instant “t3”, if a total number of packets stored in the jitter absorbing buffer 6 secondly exceeds the threshold value of the packet number judging means 9, since this condition is continued while exceeding the threshold value of the continuation monitoring timer 12, then the continuation monitoring timer 12 notifies this fact to the data discarding means 10 at a time instant “t4.” As a consequence, the data discarding means 10 discards a portion of the data stored in the jitter absorbing buffer 6.

As indicated in the above explanation, in accordance with the second embodiment mode, the data is discarded only in such a case that the total number of packets stored in the jitter absorbing buffer 6 becomes larger than, or equal to a predetermined amount, and further, this condition is continued. However, the data discarding operation is not carried out in such a case that the packets are reached in the burst manner due to a certain reason during the data communication, and therefore, a total number of packets stored in the jitter absorbing buffer 6 is temporarily increased. Only when this condition is continued, the data discarding operation is carried out. As a result, even in such a case that the delay jitters occurred in the transfer network are increased and the packets are reached in the burst manner, only the delays occurred when the first packet is transferred during the communication can be reduced, while the data is not discarded due to this adverse influence. As a consequence, it is possible to provide the voice reception service with the high quality.

(Third Embodiment Mode)

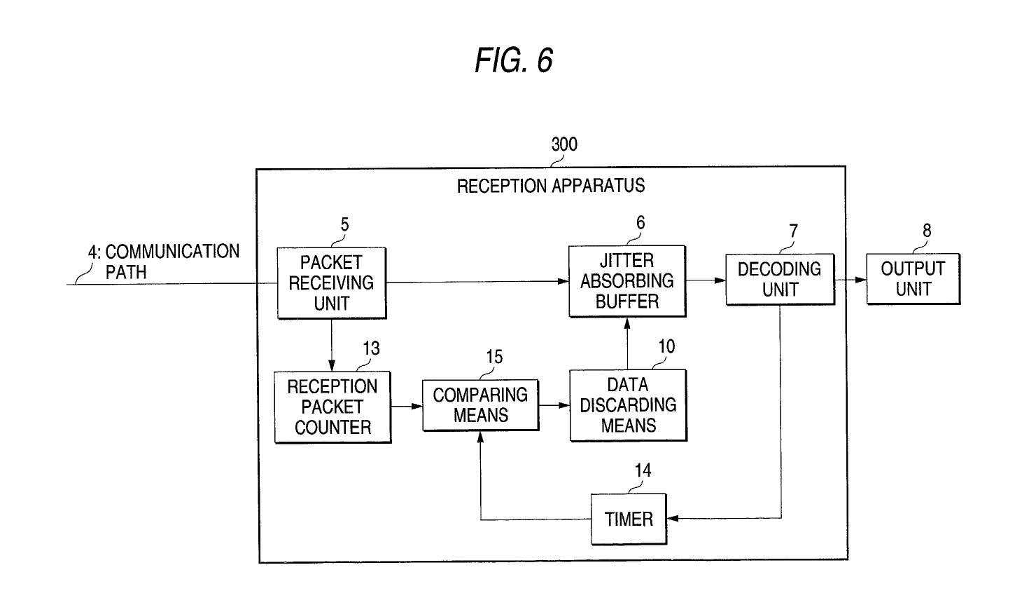

FIG. 6 represents a schematic arrangement of a reception apparatus according to a third embodiment mode of the present invention. Similar to the reception apparatus 100 of FIG. 1, the reception apparatus 300 receives real-time data from a communication path 4, which has been packetized, and then outputs decoded real-time data to an output unit 8. This reception apparatus 300 is provided with the same structural elements as those of the reception apparatus 100 except that a reception packet counter 13 is employed instead of the above-explained packet number judging means 9, and furthermore, both a timer 14 and a comparing means 15 are provided.

The reception packet counter 13 corresponds to such a counter which counts a total number of packets which have been received after a communication has been commenced. A count value of this reception packet counter 13 is added by 1 every time one packet is received. The timer 14 corresponds to a timer which commences a time counting operation at a time instant when data is decoded for the first time after the communication is commenced. When a preselected time period has elapsed, this timer 14 transfers a time-up signal to the comparing means 15. Upon receipt of the time-up signal from the timer 14, this comparing means 15 executes a comparison operation between the value of the reception packet counter 13 and a predetermined threshold value. In the case that the value of the reception packet counter 13 exceeds the threshold value, the comparing means 15 notifies such a fact to the data discarding means 10.

When such a fact that the value of the reception packet counter 13 exceeds the threshold value is notified from the comparing means 15, the data discarding means 10 operated in the unit of the packet discards either a portion of the packets or all of the packets stored in the jitter absorbing buffer 6. As to a discarding unit of packets, either a packet discarding unit or a byte discarding unit may be employed. In the case that packets are discarded in the byte unit, such data which may give a small adverse influence to a transfer quality by being discarded is selected as data to be discarded. When the real-time information corresponds to voice information, no speech (portion of data from a silent period) data is selected as the data which may give a small adverse influence to a transfer quality by being discarded.

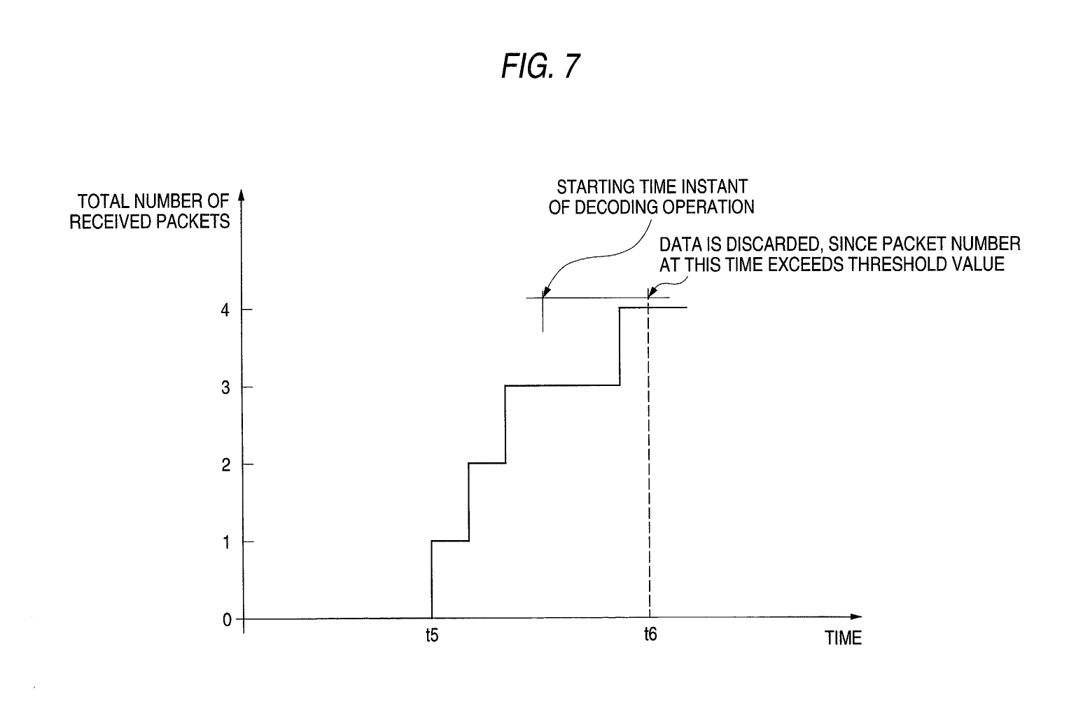

FIG. 7 represents such an example that the above-explained total number of packets is judged when the communication is commenced, and the dada is discarded. In FIG. 7, four packets are received after a packet is firstly received at a time instant “t5” after the communication is commenced, and then a predetermined time duration has passed up to a time instant “t6.” Assuming now that a threshold value of received packet number owned by the comparing means 15 is selected to be 3, the data discarding means 10 is operated so as to discard either a portion of the packets or all of the packets stored in the jitter absorbing buffer 6.

Since a coding speed of data to be transmitted is constant as well as a packet length is constant, under such a network environment that only a constant transfer delay is present without any delay jitter, a total number of packets which are received for a predetermined time period after a packet has been received for the first time is made equal to a total number of packets which are transmitted by a transmission apparatus during this predetermined time period. However, in another network such as an IP network environment in which a transfer delay is largely varied, a first packet during a communication is transferred with longer delay time than an averaged delay time, and packets subsequent to the first packet are transferred with the approximately averaged delay time. As a result, there is such a trend that the packets are reached in the burst mode in the first stage of the communication.

However, in accordance with the reception apparatus of the third embodiment mode, it is possible to discard the data in such a case that a total number of the packets which are received for a predetermined time period after the first packet has been received during the communication is larger than a total number of the packets which have been transmitted during the same time period by the transmission apparatus, this reception apparatus can discard the data. As a result, the adverse influence caused by the transfer delay of the first packet can be eliminated.

It should be noted that in the reception apparatus 300 shown in FIG. 6, since the timer 14 counts the elapsed time defined up to such a time instant when the first data is decoded after the communication has been commenced, a total number of the packets is acquired which are received during a predetermined time period after the first packet of the communication has been received. Alternatively, this timer 14 may be replaced by such a timer which may measure elapsed time after the communication is commenced.

As previously explained, in accordance with the second embodiment mode, a total number of the packets received just after the communication has been commenced is judged, and the data is discarded so as to avoid such a difficulty that the transfer delay of the first packet is stored. In particular, since the data discarding operation of the data discarding means is executed just after the communication is commenced, it is possible to minimize such a time period during which the transfer delay of the first packet may cause adverse influences. As a consequence it is possible to provide the voice reception service with the high quality.

(First Structural Example of Data Discarding Means)

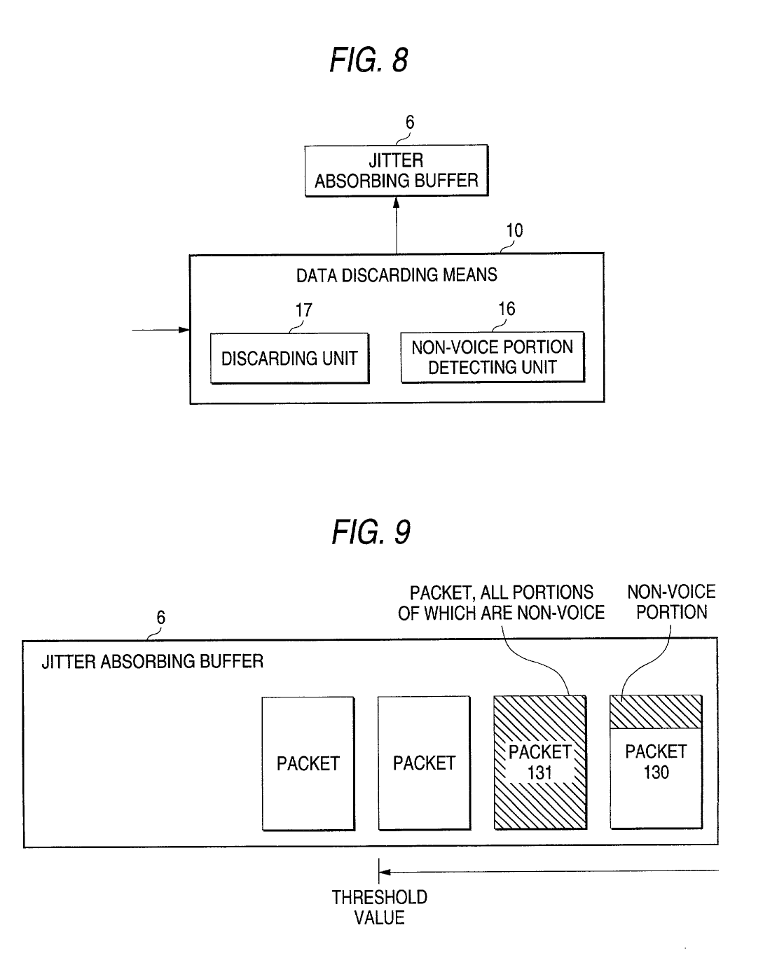

Next, a structural example of the data discarding means 10 will now be described with reference to FIG. 8 to FIG. 10. FIG. 8 shows a first structural example of the data discarding means 10, and this data discarding means 10 discards voice information (speech information) in the unit of the byte. In FIG. 8, the data discarding means 10 is arranged by a non-voice (silent, no sound) portion detecting unit 16 and a discarding unit 17.

The non-voice portion detecting unit 16 checks data stored in the jitter absorbing buffer 6 so as to detect such a portion which is coded by a code indicative of non-voice (no sound). Also, the discarding unit 17 receives a signal sent from the packet number judging means 9, the continuation monitoring timer 12, or the comparing means 15, and then, discards the non-voice data stored in the jitter absorbing buffer 6, which is detected by the non-voice portion detecting unit 16.

FIG. 9 represents an example of the above-explained judging/discarding operations of the non-voice portion. In FIG. 9, in such a case that both a hatched portion of a packet 130 and all portions of another packet 131 are coded by the code indicative of the non-voice, the non-voice portion detecting unit 16 detects such a fact that both the hatched portion of the packet 130 and all of the portions of the packet 131 correspond to “non-voice (no sound)”, and then, notifies the detection result to the discarding unit 17. The discarding unit 17 discards only the notified relevant portion from the jitter absorbing buffer 6. The data portions which are left in the jitter absorbing buffer 6 without being discarded are transferred to the decoding unit 7 so as to be decoded, and then, the decoded data portions are supplied to the output unit 8 in order to be reproduced as voice data in the normal operation.

As previously described, in accordance with the first structural example of the data discarding means 10, since the non-voice data stored in the jitter absorbing buffer 6 is discarded, it is possible to reduce the delay occurred in the first packet when the communication is commenced. In particular, since only the data of the non-voice (silent) portion is discarded, while avoiding a drop of such voice information which may probably occur by discarding the data, it is possible to reduce the delay time defined after the packet has been transmitted from the transmission apparatus and until the voice is reproduced. As a consequence, it is possible to provide the voice reception service having the high quality.

(Second Structural Example of Data Discarding Means)

Similar to the first structural example of FIG. 8, a second structural example of the data discarding means 10 is designed to discard voice information (speech information), and owns a similar arrangement to that of the second structural example. However, different from the first structural example, the non-voice portion detecting unit 16 does not notify all of such information related to a detected non-voice portion to the discarding unit 17, but equally subdivides data as to the detected non-voice portion based upon a block of a predetermined fixed byte length. Then, the non-voice portion detecting unit 16 does not notify both a head data portion and a tail data portion of this subdivided data block to the data discarding means 10, but notifies only a portion of the remaining data to the discarding unit 17. Then, this discarding unit 17 discards the notified data. As a result, only a portion of the data located at a mid-center of the continuous non-voice portion is discarded.

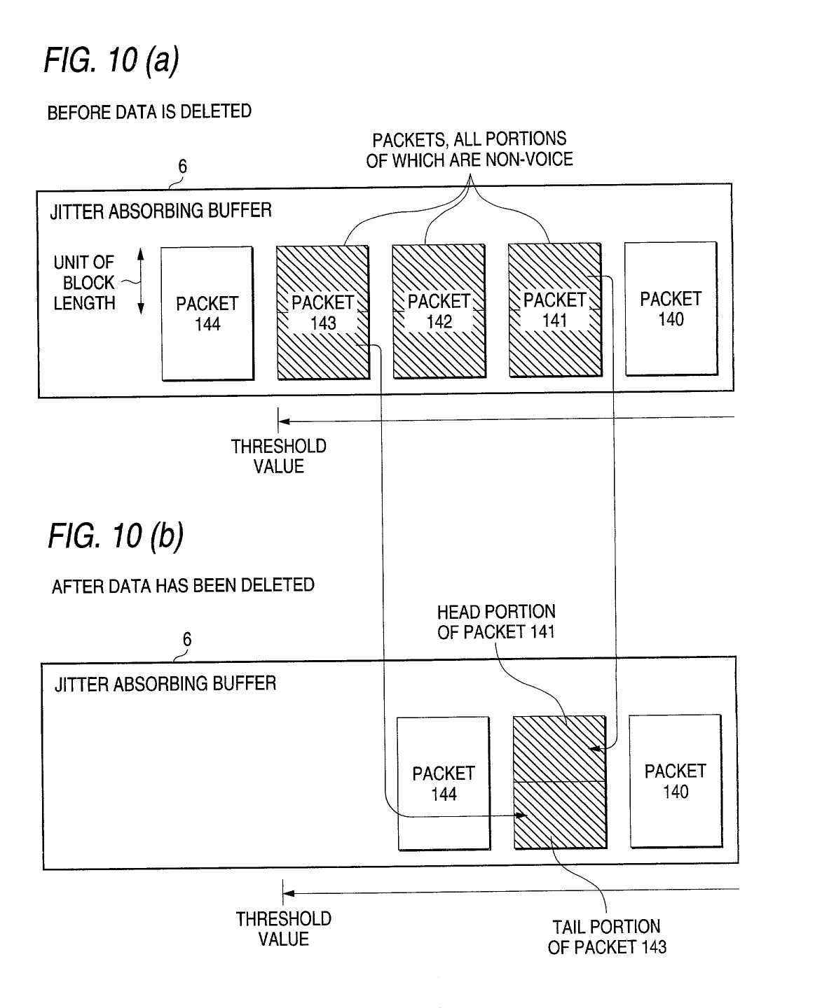

FIG. 10 indicates an example of the above-explained judging/discarding operation of the non-voice portion. In FIG. 10, both a packet 140 and a packet 144 correspond to such a packet containing no non-voice portion among the packets which are stored in the jitter absorbing buffer 6. A packet 141, a packet 142, and a packet 143 correspond to such data, all of which are coded by a code indicative of non-voice among the packets stored in the jitter absorbing buffer 6. In this case, the non-voice portion detecting unit 16 detects such a fact that the packets 141, 142, and 143 correspond to continuous non-voice data, and equally subdivides this continuous non-voice data based upon a unit block of a fixed length. Assuming now that the unit block is equal to a 1/2 packet length, the below-mentioned data is notified as data which should be discarded to the discarding unit 17. This data corresponds to such a data packet except for a head 1/2 packet of the packet 141 corresponding to a first block of the equally-divided non-voice data, and also except for a tail 1/2 packet of the packet 143 corresponding to the last block.

In the discarding unit 17, the notified data is discarded, and the data stored in the jitter absorbing buffer 6 are reconstructed. The remaining packet 140, the head 1/2 packet of the packet 141, the tail 1/2 packet of the packet 143, and the packet 144 are transferred to the decoding unit 7 so as to be decoded in accordance with the normal manner. At this time, a boundary between a voice section and a non-voice section is present at a tail of the packet 140 and also at a head of the packet 141. These portions are also left in the reconstructed data. In other words, since the non-voice portion is discarded, the two voice sections are coupled to each other. Thus, when the coupled voice sections are reproduced, it is possible to avoid occurrences of noise.

As explained above, in accordance with the second structural example of the data discarding means 10, since the non-voice data stored in the jitter absorbing buffer 6 is discarded, the delay occurred in the first packet when the communication is commenced can be reduced. More specifically, since only the non-voice data located at the mid-center among the data of the non-voice portions are discarded, it is possible to reduce the delay time defined after the packet has been transmitted from the transmission apparatus until the voice is reproduced, while preventing the following phenomenon. That is to say, since the data is discarded, the voice may be possibly interrupted, and also the voice may be coupled to each other in an unnatural manner, which can be prevented by the invention. As a consequence, it is possible to provide the voice reception service having the high quality.

(Third Structural Example of Data Discarding Means)

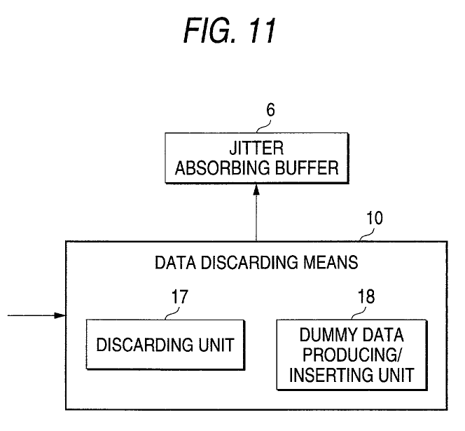

FIG. 11 shows a third structural example of the data discarding means 10 by which real-time information is discarded in the unit of a packet, or a byte. In FIG. 11, the data discarding means 10 is arranged by a discarding unit 17 and a dummy data producing/inserting unit 18.

The discarding unit 17 receives a signal from the packet number judging means 9, the continuation monitoring timer 12, or the comparing means 15, discards either a portion of data or all of these data stored in the jitter absorbing buffer 6, and then, transfers positional information of discarded data to the dummy data producing/inserting unit 18. The dummy data producing/inserting unit 18 produces such a smaller amount of dummy data than an amount of data which is discarded by the discarding unit 17, and inserts the produced dummy data into a position of data discarded by the discarding unit 17 so as to reconstruct the data stored in the jitter absorbing buffer 6. Then, the reconstructed data which are stored in the jitter absorbing buffer 6 are decoded in accordance with the normal manner.

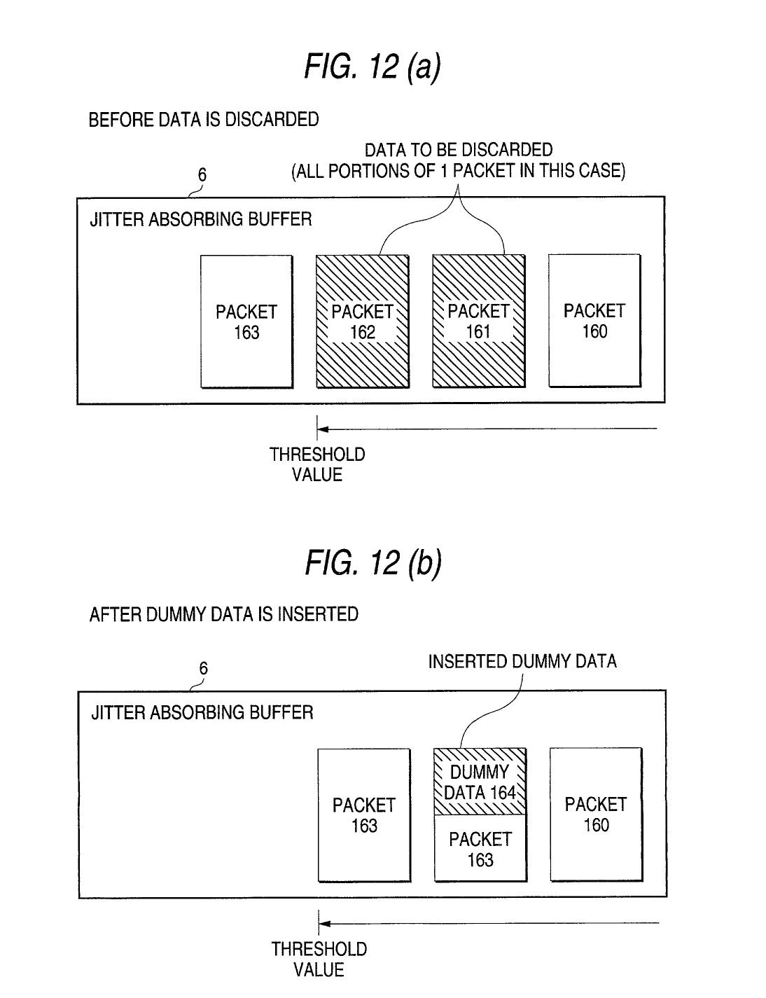

In the third structural example, FIG. 12 illustrates such a case that a packet is discarded and dummy data is inserted when real-time information is discarded in the unit of a packet. While a packet 160, a packet 161, a packet 162, and a packet 163 are stored in the jitter absorbing buffer 6 before data is discarded, there is shown such a case that entire portions of the packet 161 and also the packet 162 are discarded by the discarding unit 17. This discarding unit 17 notifies positions where both the packets 161 and 162 are present, and also data amounts of the packets 161 and 162 to the dummy data producing/inserting unit 18. The dummy data producing/inserting unit 18 produces dummy data 164 whose data amount is smaller than the notified data amount, and then, inserts this produced dummy data 164 into the positions where the packets 161 and 162 are originally present, namely between the packet 160 and the packet 163, so that the data stored in the jitter absorbing buffer 6 are reconstructed.

Alternatively, when dummy data is produced, the data of the packet 160 and the packet 163 may be checked based upon the notified positional information as to the jitter absorbing buffer 6, and then, interpolation data thereof may be effectively used as this dummy data. In the case of voice data, since two pieces of voice data are coupled to each other by employing interpolation data, when the coupled voice data is reproduced as voice, this coupled voice data may be reproduced in a natural form.

Also, when analog data is coded, such a system has been widely employed as a voice compression system with a high efficiency. That is, in this system, analog data is coded by using not only an analog signal to be coded, but also a correlative relationship between analog data acquired in the past and analog data in the future. In such a case that a packet is received which contains the data coded in accordance with the coding system with employment of such a correlative relationship, if a data discarding operation is carried out in a simple manner, then the above-explained correlative information would be lost, and there is a risk that the data cannot be decoded under normal condition in a coding unit. However, in accordance with this system, the data appearing before/after the data to be discarded are checked, and while the correlative relationship between these data is maintained, the dummy data whose data amount is smaller than that of the data to be discarded may be inserted thereinto. This system may also be applied to such a coding system using the correlative relationship.

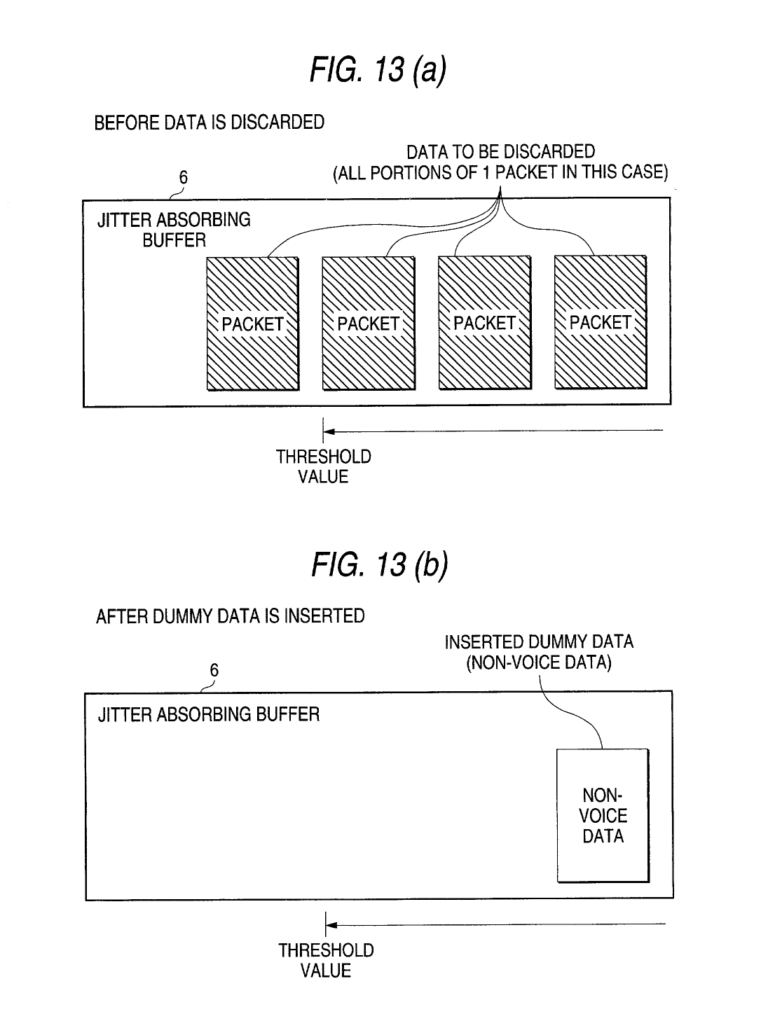

Also, as shown in FIG. 13, while all of data stored in the jitter absorbing buffer 6 are discarded, non-voice data may be employed as dummy data. In this alternative case, when a total number of packets stored in the jitter absorbing buffer 6 exceeds a threshold value, and both the discarding unit 17 and the dummy data producing/inserting unit 18 are operated, the jitter absorbing buffer 6 is brought into such a condition that only the non-voice data are stored thereinto, and such a packet which will be received later is decoded after the non-voice data have been decoded. As a consequence, the jitter absorbing buffer 6 can be regarded to have been initialized based upon new jitter absorbing time equal to the amount of the inserted non-voice data. In other words, in the case that a total number of packets stored in the jitter absorbing buffer 6 exceeds the threshold value, the jitter absorbing time may be dynamically changed, and the jitter absorbing buffer 6 may be initialized.

As previously described, in accordance with the third structural example of the data discarding means 10, the partial data among the data stored in the jitter absorbing buffer 6 is substituted by the dummy data whose data size is smaller than that of the partial data, so that the delay occurred in the first packet when the communication is commenced can be reduced. In particular, if the interpolation data as to such data located before/after the discarded data is produced as the dummy data, then the delay time defined by that after the packet has been sent from the transmission apparatus, and until the voice is reproduced can be reduced, while decreasing an occurrence of such a phenomenon that the sound is produced in the discontinuous manner and in the unnatural manner, which is caused by discarding the data. As a consequence, it is possible to provide the voice reception service having the high quality.

(Fourth Structural Example of Data Discarding Means)

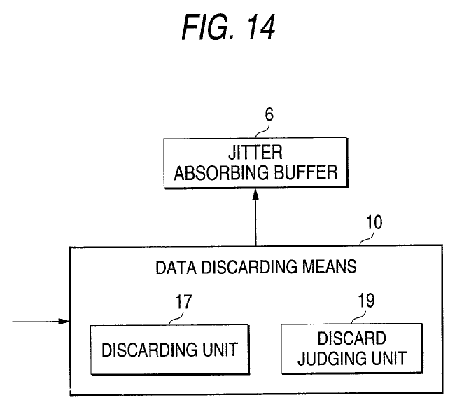

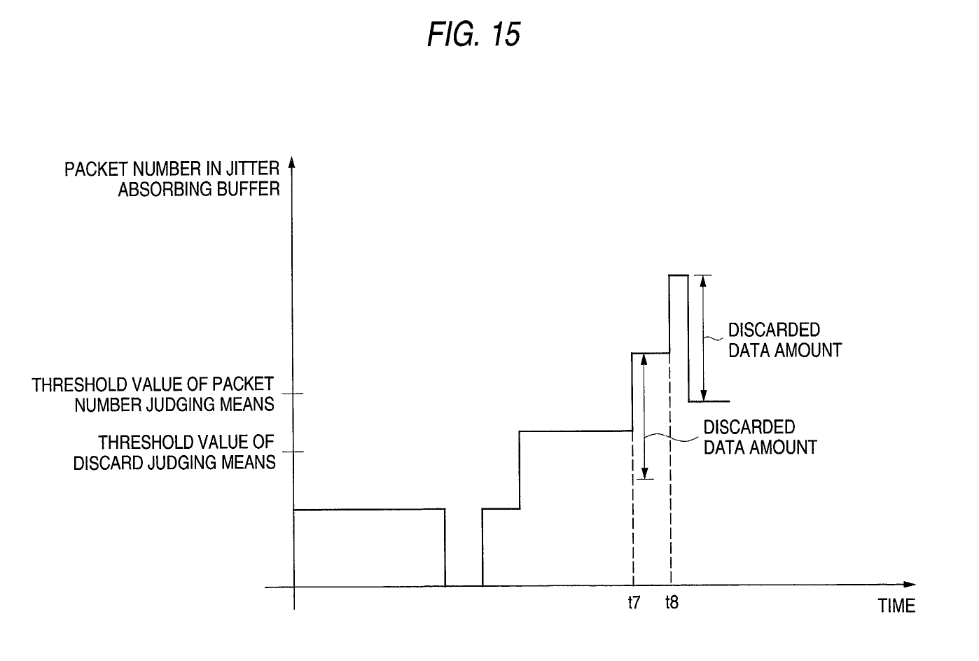

FIG. 14 shows a fourth structural example of the data discarding means 10 by which real-time information is discarded in the unit of a packet, or a byte. In FIG. 14, the data discarding means 10 is arranged by a discarding unit 17 and a discard judging unit 19.

The discarding unit 17 receives a signal from the packet number judging means 9, the continuation monitoring timer 12, or the comparing means 15, discards either a portion of data or all of these data stored in the jitter absorbing buffer 6, and also, transfers the amount of data to be discarded to the discard judging unit 19 before this discarding unit 17 actually discards the relevant data. The discard judging unit 19 calculates the amount of data after the data discarding operation based upon the amount of data to be discarded which is transferred from the discarding unit 17, and the amount of data which are presently stored in the jitter absorbing buffer 6. This discard judging unit 17 judges as to whether or not the calculated data amount is larger than a predetermined threshold value, and then transfers this judgement result to the discarding unit 17. The discarding unit 17 receives the judgement result from the discard judging unit 19, and then, discards either a portion or all of the data stored in the jitter absorbing buffer 6 in the case that the calculated data amount is larger than the predetermined threshold value. To the contrary, the discarding unit 17 does not discards the data stored in the jitter absorbing buffer 6 in such a case that the calculated data amount is smaller than the predetermined threshold value.

As a consequence, in the case that the discard judging unit 19 judges that the data amount calculated after the data discarding operation is larger than the predetermined value, the data is discarded. Conversely, in the case that the discard judging unit 19 judges that this calculated data amount is smaller than the predetermined value, the data is not discarded. As a result, it is possible to avoid such a fact that since the data is discarded, the amount of the data stored in the jitter absorbing buffer 6 is decreased lower than, or equal to the predetermined value.

FIG. 15 represents an example of the above-explained discard judging operation and data discarding operation in such a case that the data is discarded in the unit of the packet. In FIG. 15, when a total number of packets stored in the jitter absorbing buffer 6 exceeds the threshold value of the packet number judging means 9 at a time instant “t7” for the first time, the packet number judging means 9 notifies this fact to the discarding unit 17. The discarding unit 17 checks such data stored in the jitter absorbing buffer 6, which should be discarded, and then, notifies this checked data amount to the discard judging unit 19. In this example, since the notified data amount is smaller than the discard judging threshold value, the discard judging unit 19 notifies such a message that the data should not be discarded to the discarding unit 17. In response to the instruction, the discarding unit 17 does not discard the data.

A similar operation may be carried out also when a total number of packets stored in the jitter absorbing buffer 6 exceeds the threshold value of the packet number judging means 9 in the second time at a time instant “t8.” In this case, even when the data is discarded, since the total packet number exceeds another threshold value of the discard judging unit 19, the discard judging unit 19 notifies such a message that the data may be discarded to the discarding unit 17. In response to the instruction, the discarding unit 17 discards the data.

As previously explained, in accordance with the fourth structural example of the data discarding means 10, the data discarding operation is not carried out in such a case that the total packet number within the jitter absorbing buffer 6 is larger than, or equal to a constant amount, but the data amount of the jitter absorbing buffer 6 becomes such a constant amount smaller than, or equal to the predetermined threshold value upon a data discarding. To the contrary, the data discarding operation is performed in such a case that the total packet number within the jitter absorbing buffer 6 is larger than, or equal to a constant amount, and furthermore, the data amount of the jitter absorbing buffer 6 does not become such a constant amount smaller than, or equal to the predetermined threshold value upon a data discarding. When the data discarding means 10 is constructed in accordance with the above-explained structure, the delay occurred when the first packet is transferred during the communication can be reduced, while avoiding such a condition that since the data is discarded so as to recover the delay occurred in the first stage of this communication, the amount of such data stored in the jitter absorbing buffer 6 would become excessively small. As a result, it is possible to provide the voice reception service having the high quality.

(Fifth Structural Example of Data Discarding Means)

Similar to the fourth structural example shown in FIG. 14, a fifth structural example of the data discarding means 10 is designed so as to discard real-time information in the unit of either a packet or a byte, and is arranged by employing a similar structure to the fourth structural example. However, different from the first structural example, in the case that a data amount after a data discarding operation has been performed is notified from the discarding unit 17 to the discard judging unit 19, if this notified data amount is larger than a predetermined threshold value, then this discard judging unit 19 notifies such a message that all of the data may be discarded, whereas if this notified data amount is smaller than this predetermined threshold value, the discard judging unit 19 notifies such a message that the data may be discarded up to a discard judging threshold value. In response to the notified instruction, the discarding unit 17 discards all of such data which should be discarded and are stored in the jitter absorbing buffer 6 in the case that all of the data may be discarded. In such a case that the data may be discarded until the discard judging threshold value, the discarding means 17 discards the data until the data amount of the jitter absorbing buffer 6 becomes such a data amount equal to the threshold value, and does not discard the remaining data.

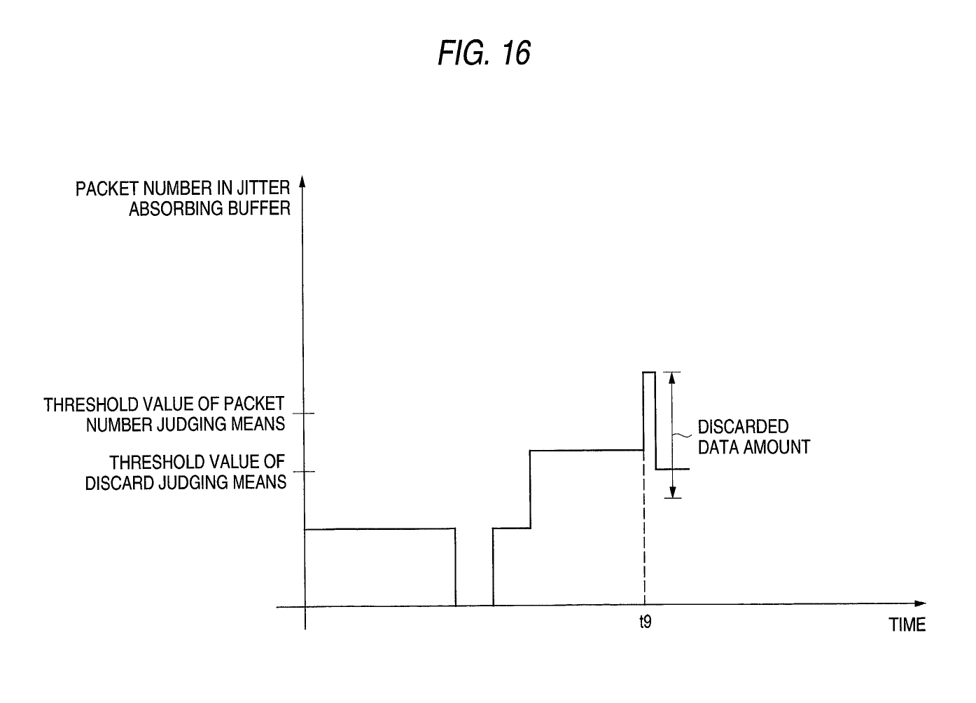

FIG. 16 represents an example of the data discarding operation executed in the fifth structural example of the data discarding means 10. In FIG. 16, when a total number of packets stored in the jitter absorbing buffer 6 exceeds the threshold value of the packet number judging means 9 at a time instant “t9” for the first time, the packet number judging means 9 notifies this fact to the discarding unit 17. The discarding unit 17 checks such data stored in the jitter absorbing buffer 6, which should be discarded, and then, notifies this checked data amount to the discard judging unit 19. In this example, since the notified data amount is smaller than the discard judging threshold value, the discard judging unit 19 notifies such a message that the data may be discarded until the discard judging threshold value to the discarding unit 17. In response to the instruction, the discarding unit 17 may discard the data until the data amount of the jitter absorbing buffer 6 becomes the discard judging threshold value, but may not discard the data when the data amount of the jitter absorbing buffer 6 exceeds this discard judging threshold value.

As previously explained, in accordance with the fifth structural example of the data discarding means 10, the data discarding operation is carried out until, but no further than, the data amount of the jitter absorbing buffer 6 becomes the discard judging threshold value in such a case that the total packet number within the jitter absorbing buffer is larger than, or equal to a constant amount but the data amount of the jitter absorbing buffer upon a full data discarding becomes smaller than, or equal to, a predetermined threshold value. To the contrary, all of the data are discarded in such a case that since the data is discarded, the data amount of the jitter absorbing buffer does not become smaller than, or equal to this predetermined threshold value. When the data discarding means 10 is constructed in accordance with the above-explained fifth structural example, the delay occurred when the first packet is transferred during the communication can be reduced, while avoiding such a condition that since the data is discarded so as to recover the delay occurred in the first stage of this communication, the amount of such data stored in the jitter absorbing buffer 6 would become excessively small. As a result, it is possible to provide the voice reception service having the high quality.

As apparent from the above-described embodiment modes, the present invention can have such an effect that the delay occurred when the first packet is transferred after the communication is commenced can be reduced, and therefore, the voice reception service with the high quality can be provided.

Also, the present invention can own such an effect that the data can be discarded by the stepwise manner in the fine level in the unit of the byte, and therefore, the delay occurred when the first packet is transferred after the communication is commenced can be reduced while the deterioration in the voice quality, which is caused by discarding the data, can be suppressed to the minimum value.

Also, the present invention can have the following advantages. That is, only when the stored delays are continued for a predetermined time duration, the data can be discarded. The data discarding operation is not carried out with respect to such a short-time delay which occurs in the burst mode while the communication is carried out, but only such a delay can be reduced which happens to occur when the first packet is transferred after the communication is commenced.

Also, the present invention can have the following advantages. That is, only when the stored delays are continued for a predetermined time duration, the data can be discarded. The data discarding operation is not carried out with respect to such a short-time delay which occurs in the burst mode while the communication is carried out, but only such a delay can be reduced which happens to occur when the first packet is transferred after the communication is commenced. In particular, the present invention can own such an effect that the data can be discarded by the stepwise manner in the fine level in the unit of the byte, and therefore, the delay occurred when the first packet is transferred after the communication is commenced can be reduced while the deterioration in the voice quality, which is caused by discarding the data, can be suppressed to the minimum value.

Also, the present invention has the following effects. That is, since the packets are discarded based upon a total number of the packets appeared just after the communication is commenced, it is possible to avoid such a fact that the transfer delay produced by the first packet is accumulated. In particular, since the data discarding operation by the data discarding means is executed just after the communication is commenced, it is possible to shorten such a time duration during which the adverse influence caused by the transfer delay produced when the first packet is transferred is given.

Also, the present invention has the following effects. That is, since the packets are discarded by judging a total number of the packets appeared just after the communication is commenced, it is possible to avoid such a fact that the transfer delay produced by the first packet is accumulated. In particular, since the data discarding operation by the data discarding means is executed just after the communication is commenced, it is possible to shorten such a time duration during which the adverse influence caused by the transfer delay produced when the first packet is transferred is given. Also, in such a case that the packet length is long, and when the data is discarded in the unit of the packet, the quality of the voice after being decoded is considerably deteriorated, there is such an advantage that since the data is discarded in the unit of the byte, it is possible to reduce the delay time of the first packet transfer operation, while suppressing the deterioration in the voice quality which is caused by discarding the data.

Also, the present invention can own the following merits. That is, since the data of the non-voice portion is discarded among the data stored in the jitter absorbing buffer 6, while preventing the dropping phenomenon of the voice information which may occur by discarding the data, the delay time can be suppressed to approximately the averaged transfer delay of the network. The delay time is defined by that after the packet has been transmitted from the transmission apparatus until the voice is reproduced.

Also, only the mid-center data portion of the continued non-voice data can be discarded. As a result, the present invention may have such a merit that the delay occurred when the first packet is transferred after the communication is commenced can be reduced, while avoiding the deterioration in the voice quality and also the occurrence of the noise, which are caused by discarding the data.

Also, the dummy data having the smaller data amount than that of the data which is discarded may be reproduced. As a consequence, the present invention can own such an effect that while the deterioration in the voice quality caused by discarding the data can be prevented, it is possible to reduce the delay occurred when the first packet is transferred after the communication is commenced. Also, when the data is encoded by way of the coding system with employment of the correlative relationship, the present invention can have such a merit that while the correlative information is maintained by inserting the dummy data, it is possible to reduce the delay occurred when the first packet is transferred after the communication is commenced. There is another effect as follows: That is, while the data is discarded, all of the data stored in the jitter absorbing buffer are discarded. As the dummy data, if the non-voice data is used, then the jitter absorbing time can be dynamically changed to the length of the non-voice data, and the jitter absorbing buffer can be initialized.

The present invention can own such an advantage. That is, it is possible to avoid that since the data are excessively discarded, the amount of data stored in the jitter absorbing buffer is excessively decreased. Also, it is possible to avoid such a condition that since the data is discarded in order to recover the transfer delay of the first packet after the communication is commenced, the data amount for the jitter absorption becomes excessively small.

Also, the data amount after the data is discarded can be kept up to a predetermined data amount. As a consequence, the present invention can have the following advantage. That is, it is possible to avoid such a fact that since the data is excessively discarded, the amount of data stored in the jitter absorbing buffer is excessively decreased. Also, it is possible to avoid such a condition that since the data is discarded in order to recover the transfer delay of the first packet after the communication is commenced, the data amount for the jitter absorption becomes excessively small.

What is claimed is:

1. A real-time information receiving apparatus for receiving real-time information transferred via an asynchronous packet network, comprising:
a packet receiving unit for receiving a real-time information packet which is transmitted at a constant coding speed, while having a constant packet length;
a jitter absorbing buffer for temporarily storing thereinto the real-time information packet received by said packet receiving unit;
a decoding unit for decoding data stored in said jitter absorbing buffer;
packet number judging means for measuring a total number of packets stored in said jitter absorbing buffer and for comparing said measured total packet number with a preset threshold value, and also for notifying the comparison result to data discarding means; and
data discarding means for discarding either a portion or all of the packets stored in said jitter absorbing buffer based upon the comparison result of said packet number comparing means.

2. A real-time information receiving apparatus for receiving real-time information transferred via an asynchronous packet network, comprising:
a packet receiving unit for receiving a real-time information packet which is transmitted at a constant coding speed, while having a constant packet length;
a jitter absorbing buffer for temporarily storing thereinto the real-time information packet received by said packet receiving unit;
a decoding unit for decoding data stored in said jitter absorbing buffer;
packet number judging means for measuring a total number of packets stored in said jitter absorbing buffer and for comparing said measured total packet number with a preset threshold value, and also for notifying the comparison result to a continuation monitoring timer; and
a continuation monitoring timer for judging as to whether or not such a time period during which said comparison result of said packet number judging means exceeds a threshold value is continued over a predetermined threshold value, and for notifying such a fact that said time period is continued over said predetermined threshold value to data discarding means; and
data discarding means for discarding either a portion or all of the packets stored in said jitter absorbing buffer based upon the comparison result of said continuation monitoring timer.

3. A real-time information receiving apparatus for receiving real-time information transferred via an asynchronous packet network, comprising:
a packet receiving unit for receiving a real-time information packet which is transmitted at a constant coding speed, while having a constant packet length;
a jitter absorbing buffer for temporarily storing thereinto the real-time information packet received by said packet receiving unit;
a decoding unit for decoding data stored in said jitter absorbing buffer;
a reception packet counter for counting a total number of real-time information packets received by said packet receiving unit after a communication is commenced;
comparing means for comparing said total packet number counted by said reception packet counter with a predetermined threshold value; and
data discarding means for discarding either a portion or all of the packets stored in said jitter absorbing buffer based upon the comparison result of said comparing means, which is acquired at a time instant when a predetermined time period has elapsed after the communication has been commenced.

4. A real-time information receiving apparatus as claimed in claim 3 wherein:
said real-time information receiving apparatus is further comprised of:
a timer for outputting a time-up signal after a predetermined time period has passed from a time instant when a first packet is received, or said data is decoded for the first time since the communication has been commenced; and
said data discarding means discards either a portion or all of the packets stored in said jitter absorbing buffer based upon the comparison result of said comparing means when said time-up signal is outputted.

5. A real-time information receiving apparatus as claimed in any one of the preceding claims 1 to 4 wherein:
said data discarding means discards either a portion or all of the packets stored in said jitter absorbing buffer in the unit of a packet.

6. A real-time information receiving apparatus as claimed in any one of the preceding claims 1 to 4 wherein:
said data discarding means discards either a portion or all of the packets stored in said jitter absorbing buffer in the unit of a byte.

7. A real-time information receiving apparatus as claimed in claim 6 wherein:
the data discarded by said data discarding means corresponds to such data which may give a small adverse influence to a transmission quality when being discarded.

8. A real-time information receiving apparatus as claimed in claim 7 wherein:
said real-time information packet corresponds to a voice packet; and
said data discarding unit is comprised of:
a non-voice portion detecting unit for detecting a non-voice portion of voice information stored in said jitter absorbing buffer; and
a discarding unit for discarding either a portion or all of said detected non-voice portions; and said data discarding means discards only the detected non-voice portion when the data discarding operation is carried out.

9. A real-time information receiving apparatus as claimed in claim 9 wherein:
said non-voice portion detecting unit notifies information as to such a non-voice portion which should be discarded within said detected non-voice portions to said discarding unit; and
said discarding unit discards only said notified non-voice portion.

10. A real-time information receiving apparatus as claimed in claim 9 wherein:
said non-voice portion detecting unit divides said detected non-voice portion by using a block having a preselected fixed length as a dividing unit, and notifies such a block except for a head block thereof and a tail block thereof as said block which should be discarded to said discarding unit.

11. A real-time information receiving apparatus as claimed in any one of the preceding claims 1 to 4 and claims 7 to 10 wherein:
said data discarding means is comprised of:
a discarding unit for discarding either a portion or all of the data stored in said jitter absorbing buffer; and
a dummy data producing/inserting unit for producing such dummy data having a smaller data amount than an amount of said data to be discarded, and for inserting said produced dummy data into said jitter absorbing buffer; and
said data discarding means inserts said dummy data instead of the data to be discarded when the data stored in said jitter absorbing buffer is discarded.

12. A real-time information receiving apparatus as claimed in any one of the preceding claims 1 to 4 and claims 7 to 10 wherein:
said data discarding means is comprised of:
a discarding unit for discarding either a portion or all of the data stored in said jitter absorbing buffer; and
a discard judging unit for judging as to whether or not an amount of data stored in said jitter absorbing buffer after the data is discarded becomes smaller than a predetermined threshold value before the data discarding operation is actually carried out; and
said data discarding means does not execute the data discarding operation in such a case that said data amount of the jitter absorbing buffer becomes smaller than the threshold value.

13. A real-time information receiving apparatus as claimed in any one of the preceding claims 1 to 4 and 7 to 10 wherein:
said data discarding means is comprised of:
a discarding unit for discarding either a portion or all of the data stored in said jitter absorbing buffer; and
a discard judging unit for judging as to whether or not an amount of data stored in said jitter absorbing buffer after the data is discarded becomes smaller than a predetermined threshold value before the data discarding operation is actually carried out; and
said data discarding means executes the data discarding operation in such a case that said data amount of the jitter absorbing buffer does not become smaller than the threshold value; and also discards only such a data amount that a data amount left in said jitter absorbing buffer is made equal to a threshold value in such a case that since there are large numbers of data to be discarded, if all of said data to be discarded are discarded, then a data amount of said jitter absorbing buffer becomes smaller than the threshold value.
